(19) United States
(12) Patent Application Publication
(10) Pub. No.: US 2014/0065496 A1
(43) Pub. Date: Mar. 6, 2014

(54) GAS DIFFUSION ELECTRODES FOR RECHARGEABLE ELECTROCHEMICAL CELLS

(71) Applicant: BASF SE, Ludwigshafen (DE)

(72) Inventors: Alexander Panchenko, Ludwigshafen (DE); Sigmar Braeuninger, Hemsbach (DE); Claudia Querner, Ludwigshafen (DE); Arnd Garsuch, Ludwigshafen (DE)

(73) Assignee: BASF SE, Ludwigshafen (DE)

(21) Appl. No.: 14/012,094

(22) Filed: Aug. 28, 2013

Related U.S. Application Data
(60) Provisional application No. 61/697,334, filed on Sep. 6, 2012.

(51) Int. Cl. H01M 4/86; H01M 12/08

(52) U.S. Cl. CPC H01M 4/8621; H01M 12/085; H01M 12/08
USPC 429/406; 429/405; 429/534; 429/528; 429/527; 429/524; 429/525; 427/115

(57) ABSTRACT

The invention relates to gas diffusion electrodes for rechargeable electrochemical cells, which comprise at least one support material bearing at least one catalyst, wherein the support material comprises at least one compound selected from the group consisting of electrically conductive metal oxides, carbides, nitrides, borides, silicides and organic semiconductors.

The present invention further relates to a process for producing such gas diffusion electrodes and also rechargeable electrochemical cells comprising such gas diffusion electrodes.

The invention relates to gas diffusion electrodes for rechargeable electrochemical cells, which comprise at least one support material bearing at least one catalyst, wherein the support material comprises at least one compound selected from the group consisting of electrically conductive metal oxides, carbides, nitrides, borides, silicides and organic semiconductors.

The present invention further relates to a process for producing such gas diffusion electrodes and also rechargeable electrochemical cells comprising such gas diffusion electrodes.

Metal-air batteries are already known. These comprise, as essential constituents, a negative electrode composed of, for example, aluminum, lithium, magnesium, cadmium, mercury, lead, iron or preferably zinc and a positive electrode which preferably consists of an electronically conductive support material composed of finely divided carbon to which a catalyst for oxygen reduction is applied. Here, negative electrode and positive electrode are separated by a separator which can be in the form of a membrane. In a widespread embodiment, metal, for example zinc, is oxidized by means of atmospheric oxygen in an alkaline electrolyte to form an oxide or hydroxide. The energy liberated here is utilized electrochemically. Commercially available metal-air batteries are at present not rechargeable. However, intensive research is being carried out on rechargeable electrochemical metal-oxygen cells in which the metal ions formed during discharge are reduced back to the metal by application of an electric potential and oxygen is liberated by oxidation of the oxides or hydroxides formed during discharge. Rechargeable electrochemical metal-oxygen cells can, depending on the metal used, be operated both with aqueous acidic electrolytes (WO2012/012558) or aqueous basic or virtually water-free electrolytes (WO2011/161595).

To produce the electrochemical cells, negative electrode, membrane and positive electrode are generally produced separately and then pressed onto one another and introduced into an enveloping container.

Metal-oxygen cells usually comprise gas diffusion electrodes. Forming gas diffusion electrodes from an electronically conductive, porous support material, for example finely divided carbon, which is coated with catalyst for catalyzing the reduction of oxygen and oxygen evolution is known. It is also known that the gas diffusion electrode can be provided with pores which during operation are covered with an electrolyte film which represents an enlarged reaction area for the catalyzed reaction in the three-phase gas/liquid/solid system. The size of the pores and the hydrophobicity or hydrophilicity of the materials used are of great importance for optimal operation in order to prevent, for example, the electrolyte from filling the pores completely since this can, for example, hinder the passage of reaction gases such as oxygen.

WO 2007/065899 A1 has disclosed bifunctional air electrodes for secondary metal-air batteries in which the active layer of the electrode comprises an oxygen reduction catalyst and La₂O₃, Ag₂O and spinels as bifunctional catalyst. WO 2005/004260 A1 discloses a process for producing a gas diffusion electrode suitable for metal-air batteries, in which an active layer and a gas diffusion layer are combined to produce the gas diffusion electrode.

It is known from US 2002/064593 A1 that a membrane-electrode assembly for fuel cells can be produced by providing a membrane with a catalyst firstly on the one side and then on the other side, with one side in each case being supported by a substrate. U.S. Pat. No. 5,861,222 A discloses gas diffusion electrodes for fuel cells, which electrodes consist essentially of a proton-conducting membrane coated with a proton-conducting polymer having a defined porosity. US 2003/118890 A1 discloses membrane-electrode assemblies for fuel cells, in which the catalyst layer of the positive electrode and/or the negative electrode has at least two sublayers of which at least one is located directly on the membrane surface. US 2004/124091 A1 discloses a process for coating electrolyte membranes for fuel cells, in which the front side of the membrane is firstly coated with a catalyst while the rear side rests on a supporting film, and the rear side is subsequently coated. US 2004/023105 A1 discloses a process for applying a catalyst ink to a substrate for fuel cells at controlled humidity and temperature. US 2007/077350 A1 discloses the production of electrolyte membranes for fuel cells, where the membrane is supported by a film during a coating step. CA 2,511,920 A1 discloses gas diffusion layers for fuel cells, which layers consist of a porous substrate and catalyst particles distributed uniformly thereon.

In the known gas diffusion electrodes for metal-air batteries, carbon (for example carbon black or graphite) is generally required in order to ensure the required electrical conductivity in the electrode. Carbon is frequently also used as support for the oxygen reduction catalysts.

The use of electrodes having doped In₂O₃ or SnO₂ as support material and tungsten oxide, molybdenum oxide, chromium oxide, vanadium oxide or boron oxide as catalyst for fuel cells is known from US 2008/0026282 A1. JP 2008/062163 A discloses the use of metal oxide fibers in fuel cells. JP 2005/149742 A discloses electrodes having indium oxide, tin oxide or titanium oxide as support and platinum, iridium, silver or palladium as catalysts for fuel cells.

One problem associated with the use of carbon supports for the catalysts in metal-air batteries is corrosion of the carbon support (Journal of Power Sources 195 (2010) 1271-1291, Journal of The Electrochemical Society, 158 (5) A597-A604 (2011), Journal of New Materials for Electrochemical Systems 2 227-32 (1999). The corrosion is caused in metal-air batteries by, in particular, different potentials. In operation of the metal-air battery, carbon is subjected to great chemical and electrochemical stress. The stability of the carbon limits the choice of a suitable electrolyte and the working voltage (maximum charging voltage) of the battery.

It was an object of the invention to improve the stability of the gas diffusion electrodes used for metal-air batteries and thus prolong their functional life.

The invention provides gas diffusion electrodes for rechargeable electrochemical cells, which comprise at least one support material bearing at least one catalyst, wherein the support material comprises at least one compound selected from the group consisting of electrically conductive metal oxides, carbides, nitrides, borides, silicides and organic semiconductors.

For the purposes of the invention, the support material is the material which bears the catalyst in the electrode. The support material preferably has a surface area, measured by the nitrogen adsorption technique at 77 K, of at least 1 m²/g, preferably from 2 to 100 m²/g.

The carbides, nitrides, borides or silicides are the corresponding metal compounds, i.e. metal carbides, metal nitrides, metal borides or metal silicides, with particular preference being given to the corresponding transition metal compounds, in particular transition metal carbides and transition metal nitrides.

In a preferred embodiment of the present invention, the gas diffusion electrode of the invention does not comprise any elemental carbon as support material. This means, in particular, that the catalyst is not fixed on a surface of a support material which comprises or consists of elemental carbon.

In a very particularly preferred embodiment, the metal oxide, in particular the zinc or tin oxide, is doped with aluminum or antimony. Particular preference is given to aluminum-doped zinc oxide and antimony-doped tin oxide.

In a further embodiment of the present invention, the support material of the gas diffusion electrode of the invention comprises aluminum-doped zinc oxide or antimony-doped tin oxide.

For the purposes of the present invention, the electrically conductive carbides, nitrides and borides to be used according to the invention as support material are preferably interstitial compounds. In these, the relatively small atoms of the carbon, nitrogen or boron are located at nonlattice sites in the respective transition metals. Particularly preferred carbides and nitrides are
WC, Mo₂C, Mo₂N, TiN, ZrN,
WC/W2C, Mo₂C carbidized on carbon (by impregnation with tungstate/molybdate solution and calcination under nitrogen, with the carbon support being the carbon source).

Further preferred materials are tantalum carbide/nitride and also mixed carbides/nitrides.

In a further embodiment of the present invention, the support material of the gas diffusion electrode of the invention comprises a nitride or carbide.

Preferred transition metals for forming the carbides, nitrides, borides and silicides are, in particular, tungsten, molybdenum, titanium, zirconium.

In a further embodiment of the present invention, the support material of the gas diffusion electrode of the invention comprises WC, Mo₂C, Mo₂N, TiN, ZrN or a mixture thereof.

The compounds used as support material (metal oxides, carbides, nitrides, borides and silicides) are preferably prepared in such a way that they have a particle size of less than 50 μm, in particular less than 20 μm.

In a preferred embodiment, the support materials used in the production of the gas diffusion electrode (metal oxides, carbides, nitrides, borides, silicides, organic semiconductors) are admixed with a preferably polymeric binder, in particular a binder based on Teflon or polyvinylidene difluoride (PVDF). Here, preference is given to using a proportion by weight based on the support material of from 10 to 60% of binder, i.e. from 0.1 to 0.6 parts by weight of binder.

For the purposes of the present invention, the starting materials used for producing the transition metal-comprising support materials can be, for example, the aqueous solutions of nitrates or chlorides of these metals. The oxides as such can likewise be used. These are preferably subjected to a heat treatment, in particular at a temperature of from 200 to 700° C., in particular from 250 to 500° C.

In a particularly preferred embodiment, the support materials, in particular the oxides or doped oxides used, are employed in the form of nanofibers. For the present purposes, nanofibers are fibers having a length of preferably from 50 to 5000 nm, in particular from 100 to 2000 nm. These preferably have a ratio of length to diameter of from 4 to 1000. In a particularly preferred embodiment, the nanofibers are obtained from a spinnable formulation. A particularly preferred spinning process is the electrospinning process. The electrospinning process makes it possible to produce fibers which are generally obtained directly in the form of sheet-like textile structures.

In a further embodiment of the present invention, the support material, in particular the metal oxide, is present in the form of nanofibers in the gas diffusion electrode of the invention.

To produce a metal-comprising support material, in particular a metal oxide, in the form of nanofibers by electrospinning, a solution of a corresponding metal salt, in particular a citrate or acetate of the metal oxide, and optionally the doping component in a solvent or solvent mixture is admixed with a polymer.

The solvent is, in a preferred embodiment, water or aqueous, in particular a water/alcohol mixture, in particular a water/ethanol mixture. In addition to water and water/ethanol mixtures, solvent mixtures of water/isopropanol are particularly preferred. The polymer added to the solution of the metal salt is used as binder. Preferred polymers of this type are polyvinyl alcohols and polytetrafluoroethylene.

Variant 1, Electrospinning

The electrostatic spinning is preferably carried out by introducing a solution or colloidal dispersion of the spinning solution composed of metal salt, solvent and polymer into an electric field having a strength of generally from 0.01 to 10 kV/cm, preferably from 1 to 6 kV/cm and particularly preferably from 2 to 4 kV/cm, by expressing it under low pressure from one or more cannulas. As soon as the electric forces exceed the surface tension of the droplets at the cannula tip(s), mass transport in the form of a jet to the opposite electrode occurs. Any solvent present vaporizes in the interelectrode space and the solid of the formulation is then present in the form of fibers on the counterelectrode. Spinning can be carried out in both vertical directions (from the bottom upward and from the top downward) and in the horizontal direction.

Variant 2, Rotor Spinning

In this variant, a solution, dispersion or melt comprising the support material or a precursor thereof is introduced into a vessel in which a metal roller is continually rotated or the spinning formulation is metered onto the roller by means of a separate device. The roller can be smooth, structured or provided with metal wires. Here, part of the formulation remains continually on the roller surface. The electric field between the roller and the counterelectrode (above the roller) results in liquid jets firstly being formed from the formulation and these then losing solvent present or solidifying from the melt on the way to the counterelectrode. The desired nanofiber nonwoven (sheet-like textile structure) is formed on a substrate (e.g. polypropylene, polyester or cellulose) which passes between the two electrodes. The electric field generally has the strength indicated in variant 1. For example, the electric field in variant 2 particularly preferably has a strength of about 2.1 kV/cm (82 kV at an electrode spacing of 25 cm). Spinning can be carried out in both vertical directions (from the bottom upward and from the top downward) and in the horizontal direction. The substrate with the sheet-like textile structure is dried.

The electrodes coated by way of example according to these variants 1 and 2 are preferably treated at temperatures above the melting point or glass transition temperature in order to join the fibers at the crossing points or join the individual polymer particles to one another in the dispersion process.

In a further embodiment of the present invention, the support material of the gas diffusion electrode of the invention comprises an organic semiconductor.

The organic semiconductors to be used as support material are preferably
linearly fused ring systems (e.g. oligoacenes such as anthracene, pentacene and derivatives thereof (e.g. quinacridone), or else, for example, benzenethiolates)
two-dimensionally fused ring systems (e.g. perylene, PTCDA and derivatives thereof, naphthalene derivatives, hexabenzocorones)
metal complexes (e.g. phthalocyanines, or Alq3, Beq2) dendritic molecules, starburst molecules (e.g. 4,4′,4″-tris(N,N-diphenylamino)triphenylamines (TDATA))
heterocyclic oligomers (e.g. oligothiophenes, oligophenylenevinylenes)
heterocyclic polymers (e.g. polythiophenes, polyparaphenylene, polypyrrole, polyaniline)
hydrocarbon chains (e.g. polyacetylene, polysulfur nitrides).

Particularly preferred organic semiconductors have an electrical conductivity of from 10⁻⁵ to 10⁶ Scm⁻¹, in particular from 10⁻⁴ to 10³ Scm⁻¹. Particularly preferred organic semiconductors are perylenes, in particular Paliogen® rot L4120.

In a preferred embodiment, the semiconductors correspond to one of the following formulae:

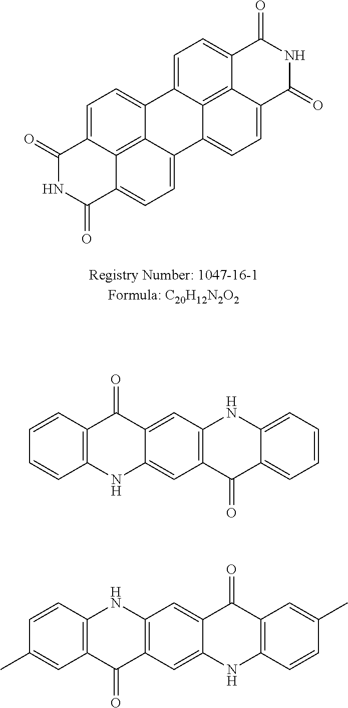

In a preferred embodiment of the present invention, the organic semiconductor in the gas diffusion electrode of the invention is a perylene.

If organic semiconductors are used as support materials, these are preferably, as powder, converted into a slurry or suspension by means of a liquid, preferably water, and then subjected to shaping, optionally together with the catalyst.

The support materials to be used according to the invention can in principle be used without a further porous medium, i.e. gas-permeable medium, which serves as substrate for stabilizing and shaping the support material and, furthermore, ensures contact of the support material and the catalyst fixed thereon with oxygen. In this case, the support materials can be mixed directly with the catalyst, or they can be processed further to form fibers or sheet-like structures and then coated with the catalyst.

In a further embodiment, the support material is, optionally together with the catalyst, applied to a gas-permeable medium. Such a gas-permeable medium can be, for example, a nonwoven, e.g. made of carbon fibers, or glass fibers. Further suitable gas-permeable media are, in particular, metal meshes, metal foams, etc. The gas-permeable medium serves, as mentioned above, essentially for mechanical stability and shaping, but also improves electric contacting if it is itself electrically conductive.

In a preferred embodiment of the present invention, the gas diffusion electrode of the invention further comprises a gas-permeable medium on which the support material is fixed.

For the purposes of the present invention, suitable catalysts which are fixed on the support material are, in particular, mixed oxides, for example cobalt oxides, nickel oxides, iron oxides, chromium oxides, tungsten oxides and also noble metals, in particular silver. In a preferred embodiment, a catalyst combination of a catalyst which catalyzes the reduction of oxygen and a bifunctional catalyst as described in WO 2007/065899 A1, page 7, line 14 to page 8, line 27, is used. A preferred catalyst which catalyzes both oxygen oxidation and reduction is La₂O₃. Preferred catalysts for the reduction of oxygen are MnO₂, KMnO₄, MnSO₄, SnO₂, Fe₂O₃, Co₃O₄, Co, CoO, Fe, Pt, Pd, Ag₂O, Ag, spinels or perovskites.

In a preferred embodiment of the present invention, at least one catalyst on the support material in the gas diffusion electrode of the invention is selected from the group consisting of La₂O₃, MnO₂, KMnO₄, MnSO₄, SnO₂, Fe₂O₃, Co₃O₄, Co, CoO, Fe, Pt, Pd, Ag₂O, Ag, spinels and perovskites.

Support material and catalyst can be mixed with one another in a manner known per se. In a preferred embodiment, the support material is stirred together with the catalyst and dispersed by means of ultrasound, in particular in the presence of an alkoxylated alcohol.

The catalyst-bearing support material is preferably, optionally together with further auxiliaries such as binders and liquids which are easy to remove, applied to a gas-permeable medium, preferably in the form of one or more layers which will hereinafter be referred to as catalyst-comprising layers.

In a preferred embodiment, at least one function-relevant parameter can be changed continuously and/or discontinuously in the catalyst-comprising layer in the direction from the gas-permeable medium to the outside. For the purposes of the present invention, a function-relevant parameter is a parameter which substantially influences the function of the catalyst-comprising layer, in particular the stability, especially the stability on repetition of many charging and discharging cycles, the capacity and the current density. The function-relevant parameter is preferably the porosity, the hydrophobicity and/or the catalyst composition, in particular the chemical composition, the quantitative composition and/or the morphology of the constituents used.

The desired porosity in the individual catalyst-comprising layers is preferably set by means of a different concentration of pore formers or by use of different pore formers. Preferred pore formers are decomposable organic or inorganic compounds, for example carbonates, in particular ammonium, potassium or sodium carbonate, low molecular weight organic compounds, for example urea, ammonium oxalate, or organic polymers.

The desired porosity is set by means of these pore formers by suitable treatment. The inorganic substances are preferably decomposed and/or leached out by treatment with an acid or alkali. The organic substances are preferably decomposed by means of a suitable thermal treatment, in particular at temperatures of from 100 to 400° C., in particular from 150 to 330° C.

The hydrophobicity of the individual catalyst-comprising layers or within a layer is preferably set by varying the proportion of a hydrophobic binder, e.g. Teflon or polytetrafluoroethylene.

The catalytic activity can preferably also be set by using different amounts of the catalyst or different catalysts or modifications thereof.

The present invention further provides a process for producing a gas diffusion electrode for rechargeable electrochemical cells, in particular a gas diffusion electrode according to the invention as described above, which comprises at least one support material bearing at least one catalyst, wherein the support material comprises at least one compound selected from the group consisting of electrically conductive metal oxides, carbides, nitrides, borides, silicides and organic semiconductors, which comprises the process steps:
a) provision of a support material selected from the group consisting of electrically conductive metal oxides, carbides, nitrides, borides, silicides and organic semiconductors
   and
b) application of a catalyst to the support material.

The description and preferred embodiments of the components support material and catalyst and for the application of catalyst to support material in the process of the invention correspond to the above description of these components for the gas diffusion electrode of the invention.

The production of particularly preferred gas diffusion electrodes according to the invention comprises the following steps:
1. Provision of a suitable nonwoven, in particular a carbon fiber nonwoven, e.g. nonwoven material from Freudenberg, e.g. of the type H2315 IX11 CX45.
2. Production of a dispersion or solution of a coating composition composed of support material and catalyst.
3. Application of the coating composition in dispersion or solution by screen printing, spraying or doctor blade coating.
4. Drying of the applied composition by heating.
5. Optionally calendering.

The gas diffusion electrode of the invention is particularly suitable for the construction of long-life rechargeable electrochemical cells, in particular for the construction of rechargeable metal-oxygen cells, in particular zinc-oxygen cells, which are preferably assembled to produce zinc-air batteries.

The present invention further provides a rechargeable electrochemical cell comprising a metallic negative electrode, a gas diffusion electrode according to the invention as described above and a separator separating the two electrodes.

In the rechargeable electrochemical cell according to the invention, a gas, in particular molecular oxygen O₂, is reduced at the gas diffusion electrode during discharge of the cell. Molecular oxygen O₂ can be used in diluted form, for example in air, or in highly concentrated form.

In a further embodiment of the rechargeable electrochemical cell of the invention, molecular oxygen is reduced at the gas diffusion electrode during discharge of the electrochemical cell.

Furthermore, rechargeable electrochemical cells according to the invention comprise at least one metallic negative electrode, frequently also referred to as anode, comprising conventional metals, preferably iron, aluminum, magnesium, lithium, sodium or in particular zinc. The metal can be present as a solid plate, as a sintered, porous electrode, as metal powder or granular material, optionally sintered. In a preferred embodiment, the metal, in particular zinc, is used as powder in a particle size of preferably from 2 to 500 μm for producing the negative electrode. In a further preferred embodiment, the powder is admixed with a binder to improve the dimensional stability. Suitable binders can be organic or inorganic in nature, with preference being given to, in particular, polytetrafluoroethylene (PTFE) and polyvinylidene fluoride.

In a further embodiment of the rechargeable electrochemical cell of the invention, the metallic negative electrode comprises metallic zinc, in particular in the form of a paste comprising zinc powder and a binder.

In a preferred embodiment, the metal powder, in particular the zinc powder, is used in the form of a paste with an organic binder for producing the anode, in particular using polytetrafluoroethylene (PTFE) and/or polyvinylidene fluoride as binder.

In a preferred embodiment of the rechargeable electrochemical cell of the invention, the electrochemical cell is a zinc-oxygen cell.

The rechargeable electrochemical cell of the invention further comprises a separator for separating negative electrode and positive electrode so as to prevent a short circuit between negative electrode and positive electrode while allowing the migration of ions between the electrodes.

Suitable separators are polymer films, in particular porous polymer films, which are unreactive toward the metals of the anode, the reduction products formed at the cathode during discharge and toward the electrolyte in the rechargeable electrochemical cells of the invention. Particularly suitable materials for separators are polyolefins, in particular porous polyethylene in the form of a film and porous polypropylene in the form of a film.

Glass fiber-reinforced paper or inorganic nonwovens, e.g. glass fiber nonwovens or ceramic nonwovens, are also suitable.

Preference is given to using an alkali-resistant or acid-resistant inert material as separator in the particularly preferred zinc-oxygen cells. In a preferred embodiment, use is made of polyolefins, in particular porous polyethylene in the form of a film and porous polypropylene in the form of a film. The separator preferably has a layer thickness of from 10 to 200 μm. In addition, other acid- or alkali-resistant polymers or inorganic compounds known to those skilled in the art are suitable as separators. In acidic electrolytes, the separator can, for example, be a sulfonated polytetrafluoroethylene, a doped polybenzimidazole, a polyether ketone or polysulfone.

In a preferred embodiment, the separator has a porosity of from 30 to 80%, in particular from 40 to 70%. Here, the porosity is the ratio of void volume to total volume.

The combination of at least two electrodes, the metal electrode and the gas diffusion electrode, an electrolyte and a separator is referred to as membrane-electrode assembly (MEA). The individual membrane-electrode assemblies can be connected to one another, preferably in series. For this purpose, the individual assemblies can be fixed between bipolar plates which separate the individual cells from one another in a gastight manner and may perform the task of supplying gas and conducting away the current.

The electrolyte used for the rechargeable electrochemical cells of the invention is liquid in a preferred embodiment. In the case of zinc-oxygen cells, acids and alkalis, in particular, are used as electrolytes. In the case of lithium- or sodium-comprising negative electrodes, electrolytes used are, in particular, the electrolytes comprising nonaqueous organic solvents which are described in WO 2011/148357, page 9, line 1 to page 10, line 29, and further comprise a corresponding salt.

In another preferred embodiment, the electrolyte can also be used in gel form.

The constituents of the rechargeable electrochemical metal-oxygen cells can be present in various arrangements (stacks). Preferred stacks have the following arrangement:
Arrangement 1: bipolar plate/negative electrode/separator/gas diffusion electrode/bipolar plate
Arrangement 2: bipolar plate/positive electrode/separator/negative electrode/separator/positive electrode/bipolar plate
Arrangement 3: bipolar plate/negative electrode/separator/positive electrode/separator/negative electrode/bipolar plate

In a preferred embodiment, the separator is coated on one side with the material for forming the negative electrode, in particular metal powder, and then joined to the gas diffusion electrode to be used according to the invention on the other side. In a further preferred embodiment, the separator, for example in solution or dispersion, is applied to the negative electrode or the gas diffusion electrode and the electrodes are then joined. In a further preferred embodiment, the separator is laid on the negative electrode. The gas diffusion electrode according to the invention is laid on the other side of the separator.

Rechargeable electrochemical cells according to the invention comprise, as further components, electric connections which connect the positive electrode and negative electrode to one another. These electric connections are preferably produced by introducing electrode layers composed of conductive and corrosion-resistant materials, preferably carbon or nickel, in a manner known per se and joining these to the corresponding electrodes. Further suitable compounds are Cu alloys known to those skilled in the art, electrically conductive polymers such as polyaniline, 3,4-polyethylene dioxide thiophene-polystyrenesulfonate (PEDOT/PSS) or polyacetylene. In a particularly preferred embodiment, a composite of carbon and polymer is used.

For use, the rechargeable electrochemical metal-oxygen cells according to the invention are installed in a suitable container. This container preferably comprises polymer. It is provided with insulated connections for the electrodes and has at least one opening through which air can enter for operation of the cell.

The present invention further provides for the use of rechargeable electrochemical metal-oxygen cells according to the invention in metal-oxygen batteries, in particular zinc-air batteries. The present invention further provides metal-oxygen batteries, in particular zinc-air batteries, comprising at least one rechargeable electrochemical metal-oxygen cell according to the invention. Rechargeable electrochemical metal-oxygen cells according to the invention can be combined with one another in metal-oxygen batteries according to the invention, for example connected in series or connected in parallel. Connection in series is preferred.

The present invention further provides for the use of rechargeable electrochemical metal-oxygen cells according to the invention, as described above, in automobiles, in two-wheeled vehicles driven by an electric motor, aircraft, ships or in particular stationary energy stores.

The present invention is illustrated by the following examples, which do not, however, restrict the invention:

### EXAMPLE 1

### I. Production of a Formulation

### I.1 Production of an Ink, WC—Ink 1

In a stirred vessel, 2 g of ethoxylated trimethylnonyl alcohol, 67 g of water, 1.8 g of tungsten carbide (WC) as support, 0.75 g of Ag as discharging catalyst, 0.4 g of Fe₂(WO₄)₃ as charging catalyst were mixed by means of a magnetic stirrer. The mixture was subsequently dispersed by means of ultrasound, using the following procedure: 14 mm US ultrasonic probe, cycle 1, amplitude 45%, 8° C. cooling, magnetic stirrer 75% up to an energy input of 0.025 kWh. 3.7 g of an aqueous dispersion of polytetrafluoroethylene having a solids content of 60% were subsequently added and the mixture was stirred for 15 minutes without further ultrasound. This gave an ink according to the invention which will hereinafter also be referred to as ink 1.

### I.2 Production of an Ink, Paliogen—Ink 2

In a stirred vessel, 2 g of ethoxylated trimethylnonyl alcohol, 67 g of water, 1.4 g of the dye Paliogen® rot L4120 as support, 0.75 g of Ag as discharging catalyst, 0.4 g of Fe₂(WO4)₃ as charging catalyst were mixed by means of a magnetic stirrer. The mixture was subsequently dispersed by means of ultrasound, using the following procedure: 14 mm US ultrasonic probe, cycle 1, amplitude 45%, 8° C. cooling, magnetic stirrer 75% up to an energy input of 0.025 kWh. 3.7 g of an aqueous dispersion of polytetrafluoroethylene having a solids content of 60% were subsequently added and the mixture was stirred for 15 minutes without further ultrasound. This gave an ink according to the invention which will hereinafter also be referred to as ink 2.

### II. Production of Electrodes According to the Invention by Application of Ink 1 or Ink 2

### II.1 Production of Electrode E1

A carbon nonwoven (gas diffusion material H2315 IX11 CX45 from Freudenberg) was used as gas-permeable medium. Ink 1 from example 1.1 was subsequently sprayed at 75° C. under reduced pressure onto the nonwoven by means of a gun, with nitrogen being used for spraying. This gave a loading of 2 mg/cm², calculated for the sum of catalysts and binder.

The coated nonwoven was subsequently treated thermally in an oven, temperature: 320° C. At this temperature, the polytetrafluoroethylene (binder) became soft.

An electrode E1 according to the invention was obtained.

### II..2 Production of Electrode E2

The production of electrode E2 was carried out using the same nonwoven as in example 11.1 and this was sprayed under the same spraying conditions with the ink 2 instead of the ink 1. However, no thermal treatment was carried out.

Both electrode E1 and electrode E2 are suitable as gas diffusion electrode in a metal-air battery.

1. A gas diffusion electrode comprising a support material bearing at least one catalyst, wherein the support material comprises at least one compound selected from the group consisting of an electrically conductive metal oxide, carbide, nitride, boride, silicide and organic semiconductor.

2. The gas diffusion electrode of claim 1, comprising no elemental carbon as support material.

3. The gas diffusion electrode of claim 1, wherein the support material comprises aluminum-doped zinc oxide or antimony-doped tin oxide.

4. The gas diffusion electrode of claim 1, wherein the support material comprises a nitride or carbide.

5. The gas diffusion electrode of claim 1, wherein the support material comprises WC, Mo₂C, Mo₂N, TiN, ZrN or a mixture thereof.

6. The gas diffusion electrode of claim 1, wherein the support material comprises an organic semiconductor.

7. The gas diffusion electrode of claim 6, wherein the organic semiconductor is a perylene.

8. The gas diffusion electrode of claim 1, wherein the support material is present in a form of nanofibers.

9. The gas diffusion electrode of claim 1, further comprising a gas-permeable medium on which the support material is fixed.

10. The gas diffusion electrode of claim 1, wherein at least one catalyst on the support material is selected from the group consisting of La₂O₃, MnO₂, KMnO₄, MnSO₄, SnO₂, Fe₂O₃, CO₃O₄, Co, CoO, Fe, Pt, Pd, Ag₂O, Ag, a spinel and a perovskite.

11. A process for producing the gas diffusion electrode of claim 1, the process comprising
applying a catalyst to a support material comprising at least one compound selected from the group consisting of an electrically conductive metal oxide, carbide, nitride, boride, silicide and organic semiconductor.

12. A process for producing a gas diffusion electrode comprising a support material bearing at least one catalyst, wherein the support material comprises at least one compound selected from the group consisting of an electrically conductive metal oxide, carbide, nitride, boride, silicide and organic semiconductor, the process comprising
applying a catalyst to a support material comprising at least one compound selected from the group consisting of an electrically conductive metal oxide, carbide, nitride, boride, silicide and organic semiconductor.

13. A rechargeable electrochemical cell comprising a metallic negative electrode, the gas diffusion electrode of claim 1, and a separator separating the two electrodes.

14. The rechargeable electrochemical cell of claim 13, wherein molecular oxygen is reduced at the gas diffusion electrode during discharge of the electrochemical cell.

15. The rechargeable electrochemical cell of claim 13, wherein the metallic negative electrode comprises metallic zinc.

16. The rechargeable electrochemical cell of claim 13, wherein the electrochemical cell is a zinc-oxygen cell.

17. A metal-air battery comprising the rechargeable electrochemical cell of claim 13.

18. The gas diffusion electrode of claim 1, which is suitable for use in a rechargeable electrochemical cell.

19. The gas diffusion electrode of claim 1, wherein the support material comprises aluminum-doped zinc oxide.

20. The gas diffusion electrode of claim 1, wherein the support material comprises antimony-doped tin oxide.
